(19) United States
(12) Patent Application Publication
(10) Pub. No.: US 2016/0276857 A1
(43) Pub. Date: Sep. 22, 2016

(54) BELT MOUNTED PORTABLE DEVICE CHARGING SYSTEM

(71) Applicant: GARY TROTT, EATONTON, GA (US)

(72) Inventor: GARY TROTT, EATONTON, GA (US)

(21) Appl. No.: 15/072,259

(22) Filed: Mar. 16, 2016

Related U.S. Application Data
(60) Provisional application No. 62/133,604, filed on Mar. 16, 2015.

(51) Int. Cl. H02J 7/00

(52) U.S. Cl. CPC H02J 7/0044; H02J 7/0027

(57) ABSTRACT

Various embodiments, aspects and features of the present invention encompass an electronic charging system configured to be removably mounted to the inside of a belt for the purpose of conveniently charging an electronic device. An exemplary embodiment includes a plurality of re-chargeable batteries that can be attached to the inside of a belt via hooks, clips, magnets, hook and loop strips, or some other means such that the system resides between the user and the belt when worn.

### BACKGROUND

The present invention relates to portable battery chargers and, more particularly, to a belt mounted portable device charging system useful for charging electronic devices. Consumers are constantly connected to their smartphones and other electronic devices. Due to continual use, these devices often die before the end of the day. Because portable electronic devices have become so heavily relied upon by their users, a convenient means for charging a device is needed when a power outlet is not available.

Portable electronic devices are typically charged through the use of a power cord that plugs into a wall outlet. Consequently, in order to charge an electronic device, many users carry a power cord along with them in the hopes that they'll have access to a power outlet when their portable electronic device runs out of power.

Because access to an electric outlet is not always available, various charging systems that provide for users to charge their phones anywhere have been introduced to the market. These devices typically comprise a power source in the form of a rechargeable battery that is capable of charging the user's portable electronic device without having to be connected to an electric outlet. However, charging systems known in the art are often bulky, making them impractical for users who don't carry a handbag or some other means for transporting the charging system.

Some charging systems known in the art are integrated into a belt that may be worn by the user, thereby avoiding the need to carry the charging system in a handbag. Charging systems integrated into a belt, however, may be uncomfortable for the wearer of the belt and certainly limit the user's fashion choices, i.e., if the user wants to make use of the charging system then he has no option but to wear the specific belt into which it is integrated.

Many people have multiple belts that they change to compliment their outfits. Many users of portable electronic devices have need for a charging system. Therefore, there is a need in the art for a belt mounted portable device charging system that can be inconspicuously and removably mounted onto any belt and used as a power source for recharging an electronic device.

BRIEF SUMMARY OF THE INVENTION

Various embodiments, aspects and features of the present invention encompass an electronic charging system configured to be removably mounted to the inside of a belt for the purpose of conveniently charging an electronic device. An exemplary embodiment includes a plurality of re-chargeable batteries that can be attached to the inside of a belt via hooks, clips, magnets, hook and loop strips, or some other means such that the system resides between the user and the belt when worn. It is envisioned that in some embodiments the charging component may be articulated into multiple rechargeable batteries forming segments while in other embodiments the charging component may be comprised of flexible battery technologies known in the art of batteries. Advantageously, the segments of an articulated charging component may be hinged, or otherwise connected together, such that the system is allowed to “bend” around the waist of a user for comfort and flexibility. When needed, a user of a belt mounted portable device charging system may use a power cord compatible with the electronic device in need of charging, plug the power cord into the charging system, and inconspicuously route the cord to the electronic device residing in a pocket.

Embodiments of a belt mounted portable device charging system are not limited to the exemplary aspects and features described above and below. Certain embodiments may include additional features, or different features, while other embodiments include alternative features. As a way of example, and not limitation, it is envisioned that some embodiments of a belt mounted portable device charging system may be configured to include a self winding USB charging cord configured to plug into a portable electronic device, a segment that utilizes kinetic charging technology to keep the rechargeable battery components charged without having to plug the system into an electric outlet. It is further envisioned that in certain embodiments one or more “battery” segments may actually be configured for holding valuables such as money or credit cards. Additionally, it is envisioned that embodiments of a belt mounted portable device charging system may be operable as an extension of other wearable devices comprising various sensors or electronic components such as, but not limited to, intelligent glasses (e.g., Google Glass), fitness bands (e.g., FitBit), or smartwatches (e.g., AppleWatch), etc.

In some embodiments, charging/discharging circuitry may be housed in a segment of the system and operable to direct a power source to the battery components for charging, direct a power source directly to a connected electronic device by bypassing the battery components, allow stored power to discharge from the battery components in order to charge a connected electronic device, etc.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a perspective view of an exemplary belt mounted portable device charging system;

FIG. 2 is a top view of an exemplary belt mounted portable device charging system envisioning the charger contained between the belt and the user;

FIG. 3 is an exploded side view of an exemplary belt mounted portable device charging system showing the USB connector;

FIG. 4 depicts two top views of the charging components that may be comprised with an exemplary embodiment of a belt mounted portable device charging system; and

FIG. 5 is a top view of an exemplary belt mounted portable device charging system that envisions a tapered, malleable exterior housing that is contoured in a semi circle fashion with the flat side of the semi-circle residing against the belt of a user.

### DESCRIPTION

As described above, a belt mounted portable device charging system may comprise a housing, or a plurality of connected housing components, with a means for being removably mounted to the inside of a belt. The housing may contain a battery charger and switching circuitry (“BCS circuitry”) for directing a power source (such as a high voltage 120 Vac power source, low voltage power source, or a solar panel power source) through a converter (if required) and to one or more rechargeable battery components for charging the battery components, as would be understood by one of ordinary skill in the art. The BCS circuitry may also be configured to direct the power supply directly to a portable electronic device in need of charging or, if no external power source is available, provide for the discharge of the rechargeable batteries to a battery residing in a portable electronic device (such as a smartphone). The charging system may further comprise any number and combination of I/O including standard USB ports, micro USB ports, lighting cables, 30-pin, 12V outlets, etc. Further, it is envisioned that multiple outputs in a given embodiment of the system may vary in amperage rating for example, but not limited to, a first USB port rated at 1 A and a second USB port rated at 2.1 A. Similarly, it is envisioned that the power capacity of embodiments of the system may vary from a few thousand milliamp hours to 15,000 or more mAh, depending on the size, type and number of rechargeable battery components.

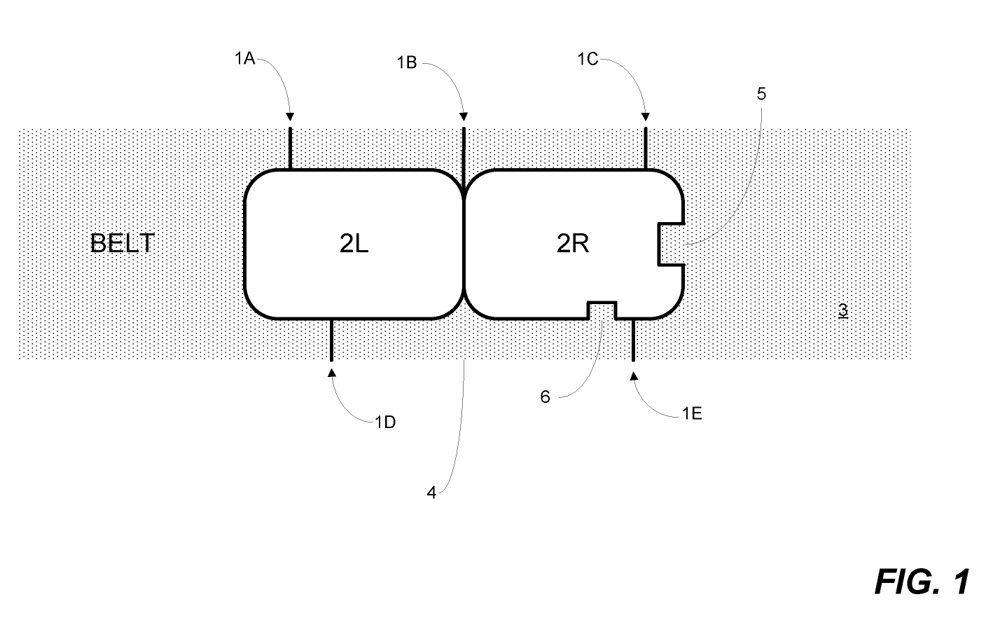

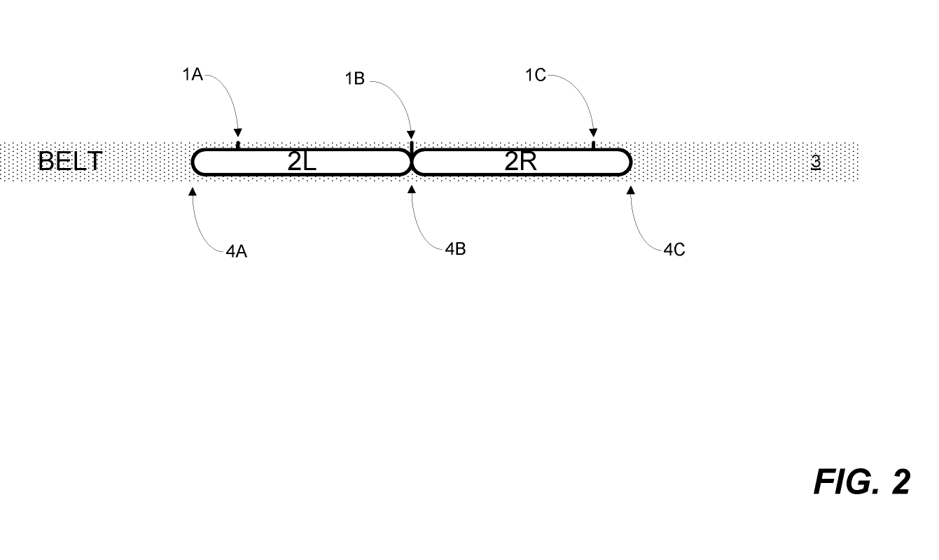

Now, turning to the figures, exemplary, non-limiting embodiments of a belt mounted portable device charging system are shown and described. FIG. 1 is a perspective view of a belt mounted portable device charging system, shown with a typical belt 3; and FIG. 2 is a top view of an exemplary belt mounted portable device charging system envisioning the charger contained between the belt 3 and the user. As can be seen in FIGS. 1 and 2, left and right charger segments 2L and 2R are connected to each other by hinge 4B. Notably, the outer ends 4A, 4B of the segments 2L and 2R may be configured to modularly received additional charger segments (not shown) and form a part of a hinge. It is envisioned that a hinge in an embodiment of the system may be of any suitable structure including, but not limited to, a pin hinge, a thin rubber portion, a pliable plastic, a woven material, etc. Moreover, a hinge 4 may be a standalone component or, in some embodiments, it may be integrated into, and form a part of, a housing component. In the exemplary embodiment, the charger system attaches to the belt 3 by hooks 1A, 1B, 1C, 1D, 1E. The USB connector 5 is envisioned on the edge of the charger connector 2R. The control to the AC power 6 is envisioned on the bottom of the charging component 2R. Certain embodiments of the solution may comprise a converter within the overall housing of the system whereas other embodiments may leverage a converter that is part of a power cord or plug for connecting to an AC power source, as would be understood by one of ordinary skill in the art.

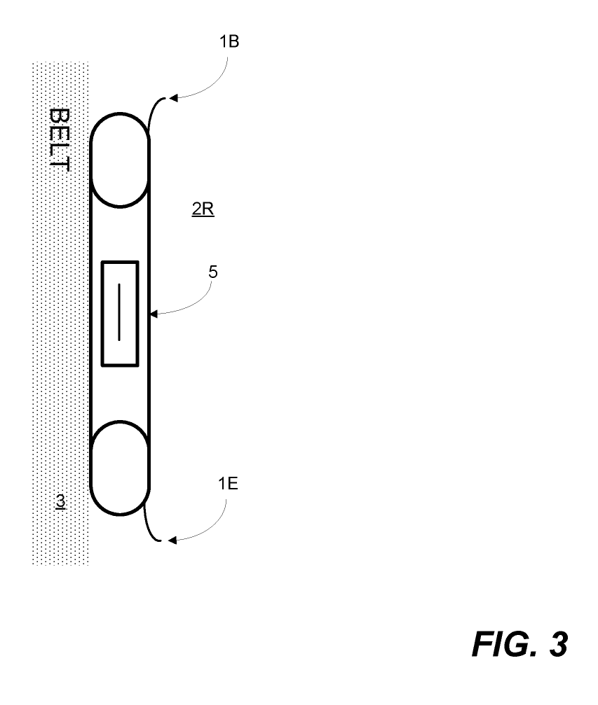

FIG. 3 is an exploded side view of a belt mounted portable device charging system showing the USB connector 5. The USB connector 5 is envisioned surrounded on top and bottom by the 2R charging component. The belt 3 is on the right side of the USB connector and the user is on the left side of the USB connector. The hook 1B that attaches the belt mounted portable device charging system to the belt 3 is above the USB connector. The hook 1E that attaches the belt mounted portable device charging system to the belt 3 is below the USB connector.

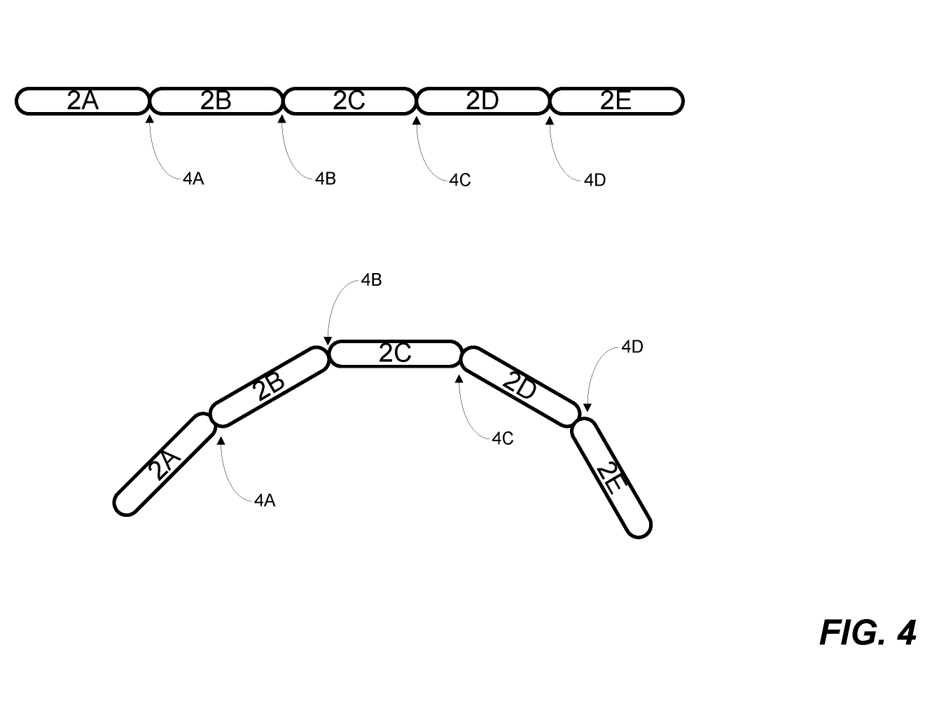

FIG. 4 is a physical mock-up of an exemplary belt mounted portable device charging system illustrating an envisioned form factor. FIG. 4 shows how an exemplary belt mounted portable device charging system may be inserted between the user and the belt.

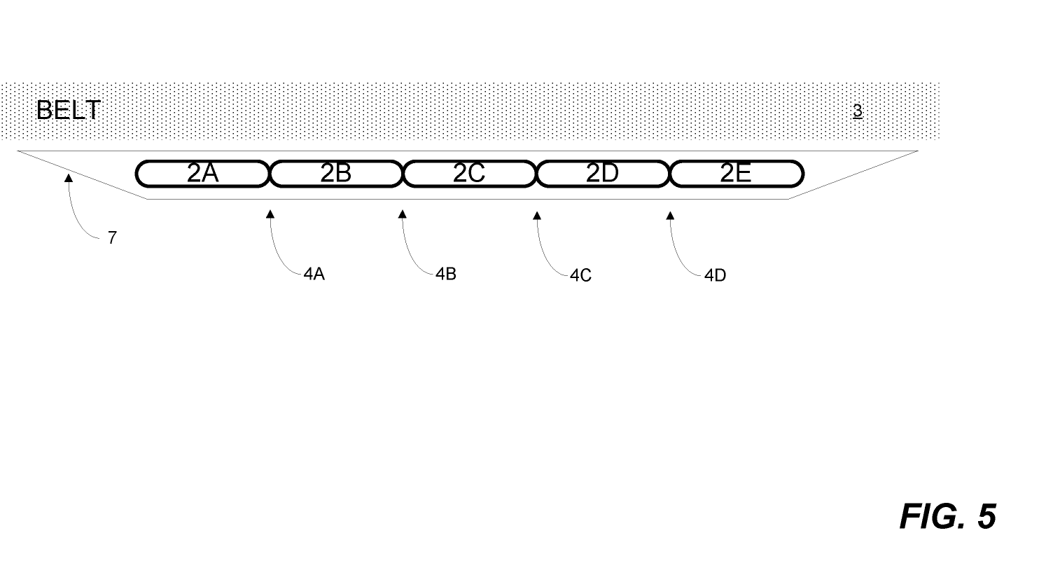

FIG. 5 depicts two top views of the charging components 2A, 2L, 2R, 2C, 2D that may be comprised with an embodiment of a belt mounted portable device charging system. The FIG. 5A illustration depicts exemplary charging components 2A, 2L, 2R, 2C, 2D that are not articulated and are thus rigid and not bendable. By contrast, the FIG. 5B illustration depicts the charging components 2A, 2L, 2R, 2C, 2D that are connected by hinges 4A, 4B, 4C, 4D that allow the charging components 2A, 2L, 2R, 2C, 2D to bend with the belt 3 and allow the system to articulate for comfort. It is envisioned that some embodiments of a belt mounted portable device charging system may provide for the modular addition of more charging components to increase the total power capacity available to a user. Moreover, it is envisioned that some embodiments of a belt mounted portable device charging system may provide for the modular addition of more components in general.

FIG. 6 is a top view of an exemplary belt mounted portable device charging system that envisions a tapered, malleable exterior housing 7 that is contoured in a semi circle fashion with the flat side of the semi-circle residing against the belt 3. The charging components 2A, 2B, 2C, 2D, 2E are shown to be contained inside of the tapered malleable exterior housing 7 (along with charging circuitry, I/O and other components not shown but understood in the art). Advantageously, the tapered malleable exterior housing 7 eliminates edges and may make an embodiment of a belt mounted portable device charging system relatively more comfortable to wear.

What is claimed is:

1. A belt mounted portable device charging system comprising:
a plurality of electrically and mechanically connected charging components, wherein the charging components are mechanically connected via hinges that allow for the articulation of the charging components relative to one another;
a housing; and
a charging port configured to receive a connector of a power source and deliver energy from the power source to the plurality of charging components;
wherein the charging components are contained within the housing.

2. The belt mounted portable device charging system of claim 1, wherein the hinges are comprised of one of a pin hinge, a thin rubber portion, a pliable plastic, and a woven material.

3. The belt mounted portable device charging system of claim 1, further comprising a converter component.

4. The belt mounted portable device charging system of claim 1, wherein the housing is tapered at its ends.

5. The belt mounted portable device charging system of claim 1, wherein one or more of the charging components is configured to modularly receive an additional charging component.
